(19) United States
(12) Patent Application Publication
(10) Pub. No.: US 2024/0414490 A1
(43) Pub. Date: Dec. 12, 2024

(54) Communication of Payload Data Through Altered Sequence of Metadata Defining Audio-Rendering Directives

(71) Applicant: The Nielsen Company (US), LLC, New York, NY (US)

(72) Inventors: Alexander Topchy, Oldsmar, FL (US); Justin Dan Mathew, Fort Lauderdale, FL (US); Jeremey M. Davis, Oldsmar, FL (US); Vladimir Kuznetsov, New York, NY (US)

(21) Appl. No.: 18/330,554

(22) Filed: Jun. 7, 2023

(51) Int. Cl. H04S 7/00; H04R 5/04

(52) U.S. Cl. CPC H04S 7/301; H04R 5/04; H04S 2400/01

(57) ABSTRACT

To facilitate communicating payload data to a destination, a computing system varies audio-rendering-directive metadata over time in a manner that represents the payload data and outputs the varied audio-rendering-directive metadata over time for communication along with an audio stream to the destination to facilitate rendering of the audio stream at the destination in accordance with the varied audio-rendering-directive metadata over time. The rendering of the audio stream at the destination conveys the payload data by being in accordance with the varied audio-rendering-directive metadata over time that represents the payload data. Thus, an audio meter operating at the destination could detect associated variation in the rendered audio stream and map that detected variation in the rendered audio stream to the payload data, thereby receiving the payload data. Varying the audio-rendering-directive metadata over time could involve varying audio-loudness specifications over time and/or varying spatial-audio specifications over time, among other possibilities.

### BACKGROUND

Recent developments in audio coding technology have introduced a new metadata construct in which metadata that accompanies an audio bitstream (e.g., a multi-media stream including audio) can carry highly granular rendering directives governing how a receiver is to render the audio.

For instance, metadata accompanying the audio track of a video broadcast may define, on a per video frame basis (e.g., every 1/30th second of compressed audio, or for a subset of those frames), general audio-rendering settings such as loudness, dialog normalization, and dynamic range control/compression, and more specific audio-rendering settings such as spatial audio output settings for particular objects, among other possibilities. Further, modern audio codecs may allow rendering adjustments to be made with even finer granularity, such as on the order of 1/50th of a second among other possibilities, whether or not aligned or associated with video frames.

Upon receipt of such metadata and audio, as the audio is decompressed, a renderer could thus read the accompanying metadata and follow the audio-rendering directives specified by the metadata so as to accordingly render the audio.

### SUMMARY

The present disclosure provides a technological advance that leverages this high level of metadata granularity as a basis to convey information that may otherwise be conveyed by watermarking the audio itself, i.e., payload data. In particular, the disclosure provides for changing or otherwise configuring the audio-rendering metadata directives over time in a manner that will cause the audio rendered according to those directives to have a time-sequence of audio variations that represents the payload data. A meter at the receiving end may then extract the payload data by monitoring the rendered audio, detecting the time-sequence of audio variations based on the monitoring, and mapping the detected time-sequence of audio variations to the payload data.

Optimally, the act of conveying payload data by altering a sequence of metadata audio-rendering directives over time can avoid the need to modify the audio itself before broadcast or other transmission, which may beneficially allow the unmodified audio to be played out by receiving systems that are not involved with the present process. Further, conveying payload data by altering a sequence of metadata audio-rendering directives over time may also help avoid the need to engage in time consuming decompression, watermarking, and recompression of the audio before transmission to the receiving end. Still further, the high temporal granularity supported by the metadata, along with sufficiently subtle changes to the audio-rendering directives, may help ensure that the audio effect of the rendered watermark remains imperceptible to human hearing.

### BRIEF DESCRIPTION OF THE DRAWINGS

FIG. 1 is a simplified block diagram of an example system in which audio with associated rendering metadata could be conveyed from a source to a destination.

FIG. 2 is a variation of the arrangement of FIG. 1, including an example encoder and an example decoder.

FIG. 3A is a simplified illustration of example audio-loudness-rendering directives corresponding with associated frames of a representative audio stream.

FIG. 3B is a simplified illustration showing how a bit sequence could be modulated onto audio-loudness-rendering directives over time.

FIG. 4A is a simplified illustration of example spatial-audio-rendering directives corresponding with associated frames of a representative audio stream.

FIG. 4B is a simplified illustration showing how a bit sequence could be modulated onto spatial-audio-rendering directives over time.

FIG. 5 is a flow chart depicting an example method.

FIG. 6 is another flow chart depicting an example method.

FIG. 7 is another flow chart depicting an example method.

FIG. 8 is another flow chart depicting an example method.

FIG. 9 is a simplified block diagram of an example computing system.

FIG. 10 is a simplified block diagram of an example meter.

### DETAILED DESCRIPTION

The present disclosure will address example implementations related to communication of payload data based on varying of audio-loudness metadata over time and/or varying of spatial-audio metadata over time. The disclosed principles, however, could apply as well to communication of payload data based on varying of other types and/or combinations of audio-rendering-directive metadata over time.

Further, it will be understood that the various arrangements and processes described herein could take various other forms. For instance, elements and operations could be re-ordered, distributed, replicated, combined, omitted, added, or otherwise modified. In addition, elements described as functional entities could be implemented as discrete or distributed components or in conjunction with other components/modules, and in any suitable combination and location. In addition, various operations described as being carried out by one or more entities could be implemented by and/or on behalf of those entities, through hardware, firmware, and/or software, such as by one or more processing units executing program instructions stored in memory, among other possibilities.

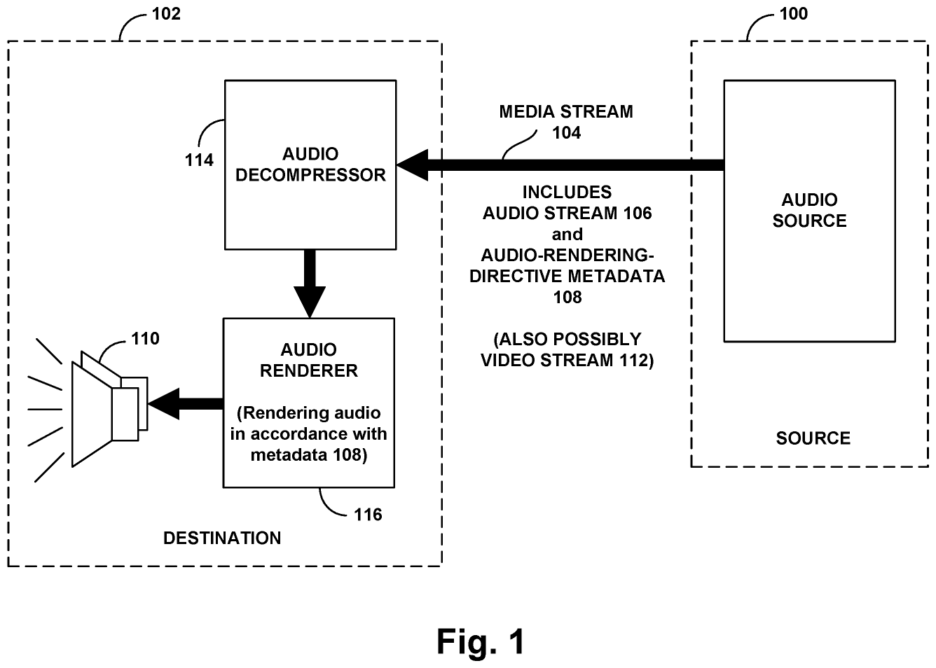

Referring to the drawings, as noted above, FIG. 1 is a simplified block diagram of an example system in which audio with associated metadata could be conveyed from a source 100 to a destination 102.

In this arrangement, equipment at the source 100 could output a media stream 104 that includes a sequence of audio data defining an audio stream 106 and that further includes a sequence of audio-rendering-directive metadata 108 indicating how to render the audio stream 106 on a per frame or other basis. (Alternatively, the audio-rendering-directive metadata 108 could be provided separate from but in correspondence with the audio stream 106.) Equipment at the source 100, and/or equipment at an intermediary device or system, could broadcast this media stream 104 for receipt by equipment at various destinations and/or could transmit the media stream 104 specifically to equipment at destination 102, among other possibilities. Equipment at the destination 102 could then receive this media stream 104, including the audio stream 106 and associated audio-rendering-directive metadata 108, and could render the audio stream 106 in accordance with the audio-rendering-directive metadata 108, to facilitate playout of the audio stream 106 by one or more sound speakers 110.

The media stream 104 in this arrangement could be audio only, including the sequence of audio data defining the audio stream 106 and the associated audio-rendering-directive metadata 108, and not including other forms of media content. In that case, the equipment at the destination 102 could receive the media stream 104 and render the audio stream 106 for playout by the one or more speakers 110 in accordance with the audio-rendering-directive metadata 108, without also engaging in rendering of other media content such as video.

Alternatively, the media stream 104 could be a multi-media stream. For instance, the media stream 104 could include both (i) a sequence of video data defining a video stream 112 and (ii) the sequence of audio data defining the audio stream 104, possibly as an audio track for the video stream, along with the associated sequence of audio-rendering-directive metadata 108. In that case, the video stream 112 may define a sequence of video frames such as 30 frames per second, the audio stream 104 may define a sequence of audio frames corresponding respectively with the video frames, and the sequence of audio-rendering-directive metadata 108 may establish how to render the audio on a per frame or other basis. Equipment at the destination 102 could thus receive the media stream 104 and render the video stream 112 for visual presentation while also rendering the audio stream 106 in accordance with the audio-rendering-directive metadata 108 for presentation by the one or more speakers 110.

The media stream 104 could be conveyed from the source 100 to the destination 102 in various ways. For instance, the media stream 104 could be streamed in real-time to the destination 102 (e.g., over the internet or through digital radio or satellite broadcast), in which case equipment at the destination 102 could render the media stream 104 for playout as the equipment at the destination 102 receives the media stream 104. Alternatively, the media stream 104 could be provided through bulk file transfer to the destination 102, such as by downloading the media stream 104 over the internet or through physical transfer of the media stream 104 on a media-storage medium such as a disc, tape, or the like. Other examples are possible as well.

As noted above, the audio data that gets conveyed from the source 100 to the destination 102 could be compressed audio data. For instance, the audio data could be digitized audio that is compressed using DOLBY AC-4 or MPEG-H audio compression or another audio compression technology, and the media stream 104 could carry the resulting compressed audio data on a per frame basis, e.g., as a sequence of audio frames. Further, if the audio data defines an audio track for associated video, the media stream 104 could carry the sequence of audio frames in synchronized correspondence with a sequence of video frames of the associated video, by interleaving the audio frames with the video frames or otherwise providing the audio and video streams in parallel and/or through use of corresponding frame timestamps or other means.

Equipment at the destination 102 could then decompress this audio data and then render the audio for output by the one or more speakers 110. To facilitate this, as shown in FIG. 1, the equipment at the destination could include an audio decompressor 114 and an audio renderer 116 (which could be provided separately or integrated together and possibly integrated with the one or more speakers 110). The audio decompressor 114 could operate on a per frame basis to decompress the compressed audio, based on the audio-compression technique that was used to compress the audio. And the audio renderer 116 could then operate to render the decompressed audio in accordance with the audio-rendering-directive metadata 108, for acoustic presentation of the audio by the one or more speakers 110.

This audio data could include multiple audio channels, enabling the audio renderer 116 to render the audio based on a corresponding speaker configuration at the destination 102.

For instance, the audio data could include stereo audio having left and right audio channels, so that if the destination 102 is configured with stereo speakers, the audio renderer 116 could render the audio in stereo, outputting the left audio channel for playout by a left speaker while outputting the right audio channel for playout by a right speaker. Further, the audio data could include 5.1 surround-sound audio including front-left, front-center, front-right, rear-left, and rear-right audio channels, so that if the destination 102 is configured with suitably-positioned 5.1 surround-sound audio speakers, the audio renderer 116 could render the audio channels for concurrent, associated playout by those speakers. Still further, the audio data could include audio channels for 7.1, 9.1, and/or other surround-sound audio, so that if the destination 102 is configured with suitably-positioned surround-sound speakers, the audio renderer 116 could likewise render the audio channels for concurrent associated playout by those speakers.

The media stream 104 could interleave these audio channels with each other or otherwise provide them in parallel or through other means, to facilitate rendering the channels at the destination 102 in synchronized correspondence with each other.

Further, the audio data could include object-based audio corresponding with particular objects. For instance, if the audio data defines an audio track for associated video, the audio data could include object-based audio that is specific to one or more video objects that appear in the video.

This object-based audio for each object may itself also include associated audio channels (e.g., left and right object-audio channels, surround-sound object-audio channels, etc.), so that the audio-renderer 116 could render the object-based audio to work with a corresponding speaker configuration at the destination 102. Further, these object-based audio channels could be likewise be provided on a per frame basis and interleaved or otherwise provided in parallel with the other audio channels of the audio data, to facilitate rendering the object-based audio in synchronized correspondence as well.

For example, if a video scene presents people talking with each other, the object-based audio data could include object-audio channels respectively for the sound of each person talking, thereby enabling the audio renderer 116 to render that object-audio respectively in relation to the video depiction of each person talking, perhaps concurrently with presentation of background audio channels. As another example, if a video scene presents a helicopter moving into and out of the scene, the object-based audio data could include object-audio channels specifically for the sound of that helicopter, thereby enabling the audio renderer 116 to present that helicopter audio in relation to the video depiction of the helicopter, also perhaps concurrently with presentation of background audio channels.

As noted above, the media stream 104 could also carry the sequence of audio-rendering-directive metadata 108 that may control how to render the audio on a per frame basis. The media stream 104 could include this audio-rendering-directive metadata 108 as a sequence of audio-rendering directives corresponding respectively with the sequence of audio frames (which may correspond respectively with a sequence of video frames), to help breathe life into each audio frame and into the audio stream 106 overall. This audio-rendering-directive metadata 108 could be interleaved with the audio data, providing in audio frame or associated packet headers, and/or conveyed in any of a variety of other ways, effectively in a virtual channel along with the audio data.

Respectively for each frame of the sequence of audio frames, for instance, the audio-rendering-directive metadata 108 could specify one or more audio-rendering parameter values to be applied by destination equipment such as the audio renderer 116 when rendering audio of that frame. These audio-rendering directives could be coded directives that are interpretable by the destination equipment to represent directives for the equipment to render the audio in a particular manner, e.g., with one or more particular audio output characteristics. Thus, after the audio decompressor 114 decompresses the audio per frame, the audio renderer 114 could render the frame of audio in accordance with the associated audio-rendering-directive metadata 108 for that frame.

As noted above, examples of these audio-rendering directives could include audio-loudness specifications and spatial-audio specifications.

Audio loudness may be proportional to the audio amplitude (which might be manually set at the destination 102) and may be characterized based on non-uniform contributions by different frequency components of the audio. Given the relative nature of audio loudness, the audio-rendering-directive metadata 108 may specify audio-loudness on a decibel (dB) scale, which could represent what loudness level should be applied when rendering the audio at the destination 102, e.g., how loud the audio output should be compared with a baseline level set at the destination.

The audio-rendering-directive metadata 108 could define audio-loudness across multiple audio channels and/or specifically on a per-audio-channel basis. For instance, for 5.1 surround-sound audio, the audio-rendering-directive metadata 108 may specify a particular audio-loudness setting to be applied to the front channels and a different audio-loudness setting to be applied to the rear channels, and/or may specify an audio loudness setting to be applied to the left channels and a different audio-loudness setting to be applied to the right channels, among other possibilities. Further, the audio-rendering-directive metadata 108 may do this specifically for the core audio channels (e.g., left, right, center, etc.) and separately for each set of object-based audio channels or may do this cooperatively for all of the audio channels.

Spatial-audio, on the other hand, generally relates to the perceptual direction of multi-speaker audio rendering, especially but not limited to object-based audio. In particular, spatial-audio specifications could relate to the perceived direction of audio from the perspective of a person positioned midway between the left and right speakers, such as a person positioned directly in front of a television with appropriately-positioned surround sound speakers. The audio-rendering-directive metadata 108 could control this perceptual direction of the audio by specifying relative loudness levels of the various speakers.

For instance, to cause the person to perceive that particular audio is pointing straight out from a plane of the front speakers, the audio-rendering-directive metadata 108 could set that audio to play with equal loudness from the left speaker(s) and the right speaker(s). Whereas, to cause the person to perceive that particular audio is angled or positioned to the left, the audio-rendering-directive metadata 108 could set that audio to play more loudly from the left speaker(s) than from the right speaker(s). And to cause the person to perceive that the audio is angled or positioned to the right, the audio-rendering-directive metadata 108 could set that audio to play more loudly from the right speaker(s) than from the left speaker(s). A similar process could apply as well to control perceptual-audio direction in three dimensions.

This approach could work well to control the perceptual direction of object-based audio as to an object depicted in a video, among other possibilities.

For instance, over the course of a series of frames in which an object is positioned at the left side of the video frame, the audio-rendering-directive metadata 108 could cause the audio renderer 116 to present that object's associated audio with a perceptual direction angled toward the left side, by directing the renderer 116 to render the object's audio with louder left channels than right channels. Whereas, over the course of a series of frames in which an object is positioned at the right side of the video frame, the audio-rendering-directive metadata 108 could cause the audio renderer 116 to present that object's associated audio with a perceptual direction angled toward the right side, by directing the renderer 116 to render the object's audio with louder right channels than left channels.

Further, over the course of a series of frames in which an object moves from the left side of the video frame to the right side of the video frame, the audio-rendering-directive metadata 108 could cause the audio renderer 116 to progressively change the perceptual direction of that object's audio from being angled toward the left to being angled toward the right, by changing the relative loudness specifications for the object's left and right audio channels accordingly. With the helicopter example noted above, for instance, this audio rendering may cause a person watching a video in which the helicopter moves from the left side of the frame to the right of the frame to perceive the angle and position of the helicopter's audio to correspondingly move from the left to the right.

The audio-rendering-directive metadata 108 could dictate perceptual-audio direction on a per frame basis in various ways. For instance, the audio-rendering-directive metadata 108 could specify per frame a perceptual-direction angle in relation to a reference angle. If the reference angle is 0° for audio directed straight out and thus centered between left and right, the audio-rendering-directive metadata 108 could specify perceptual-audio direction on a per frame basis by specifying an angle in relation to that 0° direction, which the audio renderer 116 may translate into respective left and right channel loudness levels to apply in order to effectively direct the audio in accordance with the metadata. Alternatively, the audio-rendering-directive metadata 108 could dictate perceptual-audio direction on a per frame basis by specifying the respective loudness levels respectively for left, right, and/or other channels, for the audio renderer 116 to apply in order to achieve a desired audio angle.

In an example implementation, a computing system, company, or other creator of the media stream 104 could generate the audio stream 106 and associated audio-rendering-directive metadata 108 to facilitate rendering of the audio as discussed above. For instance, the audio could be recorded with microphones suitably positioned to capture and generate audio channels including particular object audio. Further, a computing system may evaluate the recorded audio and generate the associated audio-rendering-directive metadata 108 based on that microphone input and/or based on sound-engineer input, among other possibilities. The media stream 104 including the audio stream 106 and audio-rendering-directive metadata 108 could then be stored, pending delivery to one or more destinations such as destination 102, to facilitate rendering the audio.

In line with the discussion above, the present disclosure provides for communicating payload data to the destination 102 by effectively modulating the payload data onto the audio-rendering-directive metadata 108. In particular, the disclosure provides for varying the audio-rendering-directive metadata 108 over time in a manner that represents the payload data, so that the audio as rendered at the destination 102 based on that varied audio-rendering-directive metadata 108 would end up being modulated in a manner that represents the payload data. Further, the disclosure provides for monitoring the rendered audio at the destination 102 to extract the payload data, effectively demodulating the rendered audio to ascertain the payload data that the rendered audio represents as a result of it being rendered in accordance with the varied audio-rendering-directive metadata 108.

In an example implementation, a computing system at or associated with the source 100 could operate as a data encoder to encode the payload data as a series of variations in the audio-rendering-directive metadata 108 (e.g., as part of initial creation of the metadata, or to change the metadata once created), and a computing system at or associated with the destination 102 could operate as a data decoder to decode the payload data by detecting the resulting changes in the rendered audio. The encoder and decoder may thus individually or in combination define a computing system that facilitates communication of payload data from the source to the destination based on variations in audio-rendering-directive metadata over time.

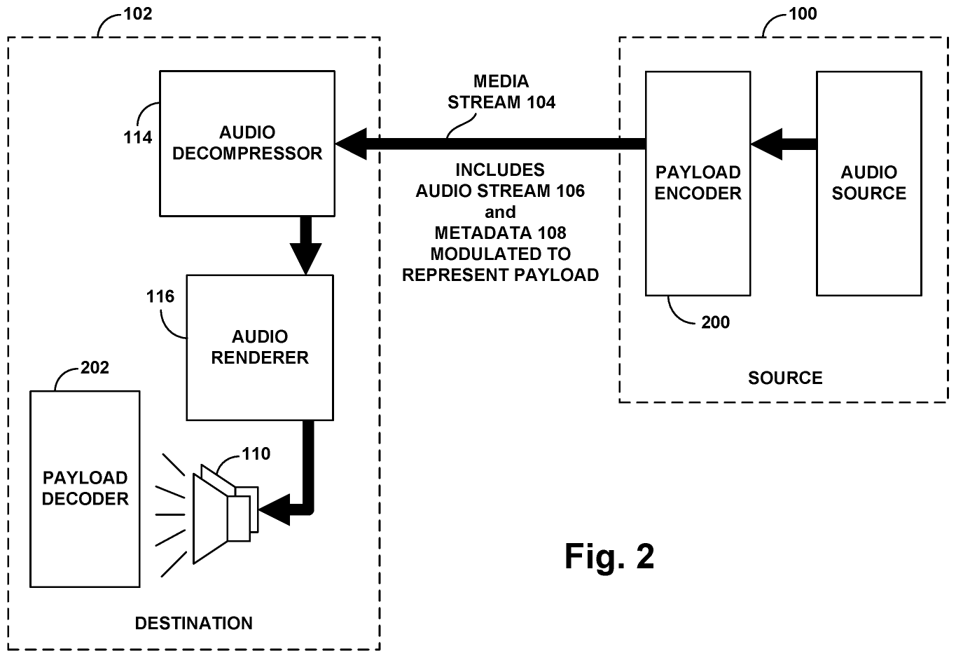

FIG. 2 is a variation of the arrangement of FIG. 1, illustrating example inclusion of an encoder 200 and a decoder 202.

As shown in FIG. 2, a computing system operating as the encoder 200 could be configured to act on an established sequence of audio-rendering-directive metadata 108 associated with the audio stream 106, in order to configure the audio-rendering-directive metadata 108 with variations cooperatively representing the payload data. In particular, in the arrangement shown, the encoder 200 could receive the sequence of audio-rendering-directive metadata 108 output by equipment at the source 100 and could modify a series of audio-rendering directives in that metadata in a manner that represents the payload data, so that when the modified metadata is applied at the destination 102, the resulting rendered audio would represent the payload data.

Further, as shown in FIG. 2, a computing system operating as the decoder 202 could be configured to monitor and evaluate the resulting rendered audio at the destination 102, in order to extract the payload data represented by the resulting variations in the audio. This decoder 202 could be provided in or associated with a meter device at the destination and could include or make use of one or more microphones positioned to receive audio from the one or more speakers 110.

To facilitate evaluating variations of audio loudness and/or spatial audio, for instance, the decoder 202 could make use of microphones situated near each speaker and/or directed to receive audio separately and respectively from each speaker. Alternatively, the decoder 202 could be configured to monitor one or more rendered audio channels by monitoring electrical or optical signaling that flows on one or more speaker cables, or in another manner. The decoder 202 could further make use of a digital signal processor or other processing system configured to evaluate one or more such audio channels, in order to detect variations in the rendered audio resulting from the variations in the audio-rendering-directive metadata 108, and thus to extract the payload data based on the detected variations.

In an example implementation, this process can involve relatively minor variations in audio-rendering directives over time. In particular, the variance in audio-rendering directives over time made to represent the payload data could be minor enough that the resulting changes in rendered audio over time would not be perceptible to a human being listening to the rendered audio but could be detected by a suitably-configured computing system or other machine monitoring the rendered audio.

For example, as to audio-loudness specifications, the audio-rendering-directive metadata 108 could be varied over time by plus or minus 1 dB (i.e., varying loudness-specifications over time by plus or minus 1 dB), which would result in changes to the rendered audio that would almost certainly not be human perceptible but could be detected by a computing system with suitable sensitivity. Further, as to spatial-audio specifications governing perceptual-audio direction, whether specified by angle or by relative channel loudness levels among other possibilities for instance, the audio-rendering-directive metadata 108 could be varied by plus or minus 3° (i.e., to specify perceptual-audio direction varied over time by plus or minus 3°), which would likewise result in changes to the rendered audio that likely not be human perceptible but could similarly be detected by a computing system with suitable sensitivity.

The payload data that could be communicated through this process could be largely any data that would be useful to communicate to the destination 102.

By way of example, the payload data could represent an identifier of the media content at issue, which, after extraction at the destination 102, could be reported to a back-office system to facilitate generating of ratings data, triggering of dynamic content revision, and/or confirming of successful receipt of the media content, among other possibilities. For instance, if the media stream 104 comprises a particular channel of content, such as a particular broadcast channel or streaming-media channel, the payload data could represent an identifier of that channel, such as a station identifier (SID) or the like. Similarly, if the media stream 104 comprises particular content such as a specific song, movie, television program, and/or commercial advertisement, the payload data could represent an identifier of that particular content.

As another example, the payload data could represent a coded directive or call-to-action, which could cause a device that receives the payload data at the destination 102 to carry out an associated action. Alternatively or additionally, the payload data could represent still other information related to the media content and/or unrelated to the media content. Further, the payload data that gets communicated through this process could be just a portion of data that represents one or more of these and/or other pieces of information.

In an example implementation, the payload data could be a bit sequence made up of zero-bits and one-bits.

Varying the audio-rendering-directive metadata 108 over time in a manner that represents this bit sequence could then involve the encoder 200 configuring bitwise variations in a series of audio-rendering directives that corresponds with a series of audio frames or other segments of the audio stream 106 (whether or not contiguous), so that the audio when rendered at the destination 102 in accordance with the varied series of audio-rendering directives would have a corresponding series of changes over time that represents the bit sequence.

For instance, the encoder 200 could map each bit of the bit sequence to a respective audio-rendering directive of a series of audio-rendering directives and could configure the audio-rendering directives respectively based on these mapped bit values. Thus, if the bit sequence is N bits long, the encoder 200 could make associated variations in a series of N audio-rendering directives that corresponds with a series of N audio frames of the audio stream 106.

Alternatively, to help make communication of the payload data more robust, the encoder 200 could spread the N-bit sequence with a pseudo-noise (PN) code to produce a spread bit sequence and could map each bit of the spread bit sequence to a respective audio-rendering directive of a series of audio-rendering directives and could configure the audio-rendering directives respectively based on these mapped bit values. For instance, the encoder 200 could spread the N-bit sequence with an M-bit (or M-chip) PN code by replacing each one-bit of the N-bit sequence with the M bits of the PN code and replacing each zero-bit of the N-bit sequence with the inverse of the M bits of the PN code, to produce an N*M bit sequence. The encoder 200 could then make associated variations in a series of N*M audio-rendering directives that corresponds with a series of N*M audio frames of the audio stream 106.

Varying a series of audio-rendering directives to represent a sequence of bits (such as the N-bit sequence of the payload data or the N*M bit spread sequence representing the payload data) could involve making the minor variations in audio-rendering directives noted above in correspondence with the bit values.

For instance, the encoder 200 could loop through the bits of the bit sequence and, for each successive bit, could make a corresponding minor variation to a next audio-rendering directive in the series of audio-rendering directives. Through this process, the encoder 200 could make a predefined audio-rendering-directive variation as to each bit of the bit sequence, such as by making a first predefined audio-rendering-directive variation as to each zero-bit and making a second, different predefined audio-rendering-directive variation as to each one-bit. Or the encoder may be able to achieve a similar result by making such variations just as to the zero-bits or just as to the one-bits.

For instance, to encode a given bit by correspondingly varying an audio-loudness specification for a given audio channel, the encoder 200 could reduce the audio-loudness specification by 1 dB if the bit is a zero-bit or could increase the audio-loudness specification by 1 dB if the bit is a one-bit. Likewise, to encode a given bit by correspondingly varying a spatial-audio specification represented by an angle of perceptual-audio direction (or by relative channel loudness that effectively defines an angle of perceptual-audio direction), the encoder 200 could reduce the angle specification by 3° if the bit is a zero bit or could increase the angle specification by 3° if the bit is a one-bit. Other examples are possible as well.

To enable the decoder 202 to detect this sequence of variations in the rendered audio over time as a representation of the payload data, the encoder 200 could further encode a predefined synchronization signal just before the sequence of variations representing the payload data. This synchronization signal could be of any predefined length, and the encoder 200 could encode the signal in the manner above by varying a corresponding series of audio-rendering directives that may be associated with a corresponding series of audio frames. For instance, the synchronization signal could be a 48-bit signal, which the encoder 200 could encode into the audio-rendering-directive metadata by varying a series of 48 audio-rendering directives corresponding with a series of 48 audio frames.

The decoder 202 could then regularly monitor for presence of this predefined series of variations in the rendered audio that would result from application of the predefined series of variations in audio-rendering directives representing the synchronization signal. And upon detecting presence of predefined series of variations in the rendered audio, the decoder 202 could then monitor the rendered audio that follows, in an effort to extract the payload data.

Making these minor variations in audio-rendering directives over time in a manner that could allow the decoder 202 to detect associated changes in the resulting rendered audio may work best with a series of audio-rendering directives that are themselves constant over time or otherwise define a predictable baseline over time. Namely, a predictable baseline of the audio-rendering directives over time could provide the decoder 202 with a perspective for detecting changes in the resulting rendered audio.

For instance, as to audio-loudness, if the audio-rendering directives define a constant loudness level of 30 dB for a front-center audio channel over the course of numerous audio frames, then making 1 dB variations to a subset of those audio-rendering directives could enable the decoder 202 to detect resulting 1 dB variations in loudness of that channel as variations from that 30 dB baseline over time. Whereas, if the audio-rendering directives define often-changing loudness levels over the course of numerous audio frames, then making 1 dB variations to a subset of those audio-rendering directives may result in changes to the rendered audio that are not detectible by the decoder 202.

Likewise, as to spatial audio, if the audio-rendering directives define a constant perceptual direction of 0° (e.g., by defining equal loudness in left and right audio channels), then making 3° variations to a subset of those audio-rendering directives could enable the decoder 202 to detect the resulting 3° variations as variations from the 0° baseline over time. Whereas, if the audio-rendering directives define often-changing perceptual-audio direction over the course of numerous audio frames, then making 3° variations to a subset of those audio-rendering directives may result in changes to the rendered audio that are not detectible by the decoder 202.

To address this issue, the encoder 200 could select from the audio-rendering-directive metadata 108 a time range of that metadata (i.e., metadata defining audio-rendering directives for an associated a time range of the audio stream 106), based on applicable audio-rendering directives throughout that time range being constant or otherwise predictable. And based on that selection, the encoder 200 could then encode the synchronization signal and payload data within that time range of the metadata. In this process, the encoder 200 could leave unvaried a sufficient number of the audio-rendering directives at the beginning of the time range, in order to enable the decoder 202 to detect the baseline before detecting the synchronization signal and payload data. Further, the encoder 200 could require that the selected time range of metadata be sufficiently log to accommodate this process.

In an example implementation, for instance, the encoder 200 could scan through the audio-rendering-directive metadata 108 in search of a sufficiently long time range of the metadata in which audio-loudness specifications for a given audio channel are constant. And upon finding such a time range, the encoder could leave an initial group of those audio-loudness specifications unchanged and could then encode into subsequent groups of the audio-loudness specifications the synchronization signal and payload data by making variations to associated audio-loudness specifications as noted above. As the decoder 202 monitors the rendered audio, the decoder may then detect the synchronization signal followed by the payload data, by detecting the associated variations in audio loudness of the audio resulting from application of the varied audio-loudness specifications over time.

In another example implementation, the encoder 200 could scan through the audio-rendering-directive metadata 108 in search of a sufficiently long time range of the metadata in which spatial-audio specifications for a given object are constant. And upon finding such a time range, the encoder could leave an initial group of those spatial-audio specifications unchanged and could then encode into subsequent groups of the spatial-audio specifications the synchronization signal and payload data by making variations to associated spatial-audio directives as noted above. As the decoder 202 monitors the rendered audio, the decoder may then detect the synchronization signal followed by the payload data, by detecting the associated variations in perceptual direction of the audio resulting from application of the varied spatial-audio specifications over time.

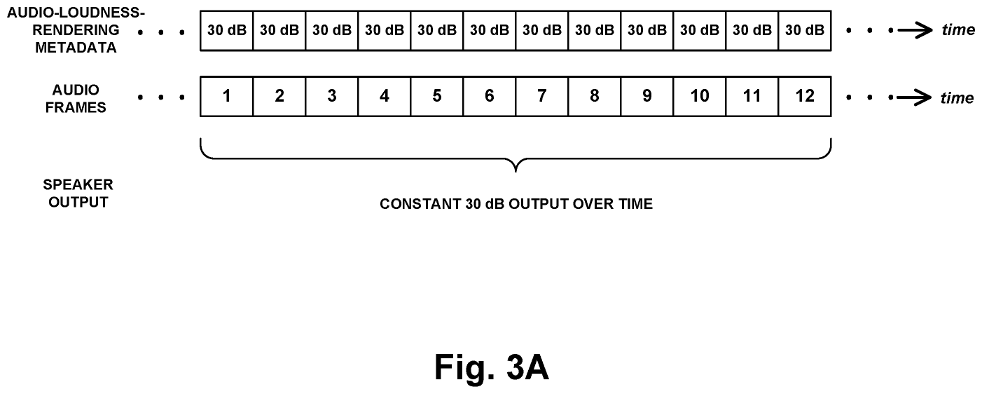

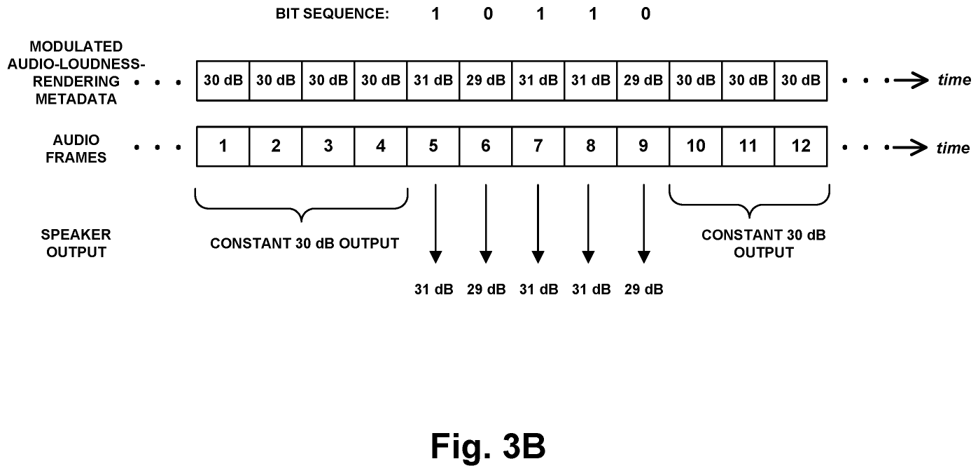

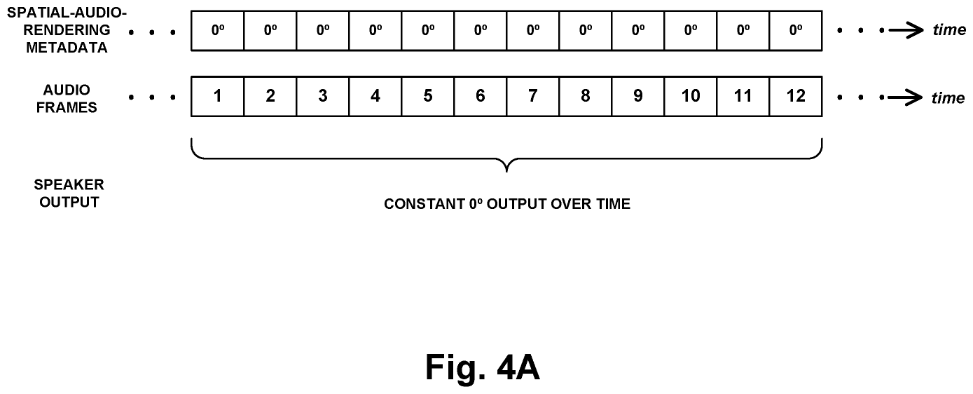

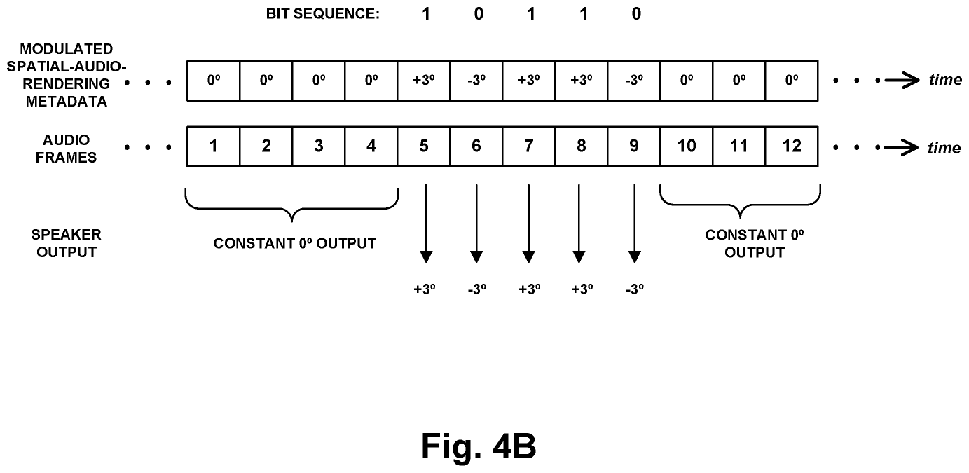

FIGS. 3 and 4 are simplified illustrations of example audio-rendering directives corresponding with associated frames of a representative audio stream, showing how the encoder 200 could vary the audio-rendering directives over time in a manner that represents an example bit sequence (e.g., a synchronization signal followed by a representation of payload data), so that the decoder 202 could detect and extract the bit sequence by detecting changes over time in the audio stream rendered according to the varied audio-rendering directives. FIG. 3 illustrates how this could be done with audio-loudness specifications, and FIG. 4 illustrates how this could be done with spatial-audio specifications.

Each of these figures shows an example audio stream including a series of audio frames over time, conceptually numbered as frames 1 through 12. Further, each figure shows example audio-rendering-directive metadata accompanying or otherwise associated with the example audio stream, including a corresponding series of audio-rendering directives over time, with each audio-rendering directive corresponding with a respective one of the audio frames and indicating how the audio of that respective frame should be rendered.

Part A of each figure illustrates how the series of audio-rendering directives may be structured when received by the encoder 200. Part B of each figure then illustrates how the series of audio-rendering directives may be modified by the encoder 200 to represent an example bit sequence, 10110, and how the decoder 202 could monitor the resulting rendered audio to extract the bit sequence by detecting changes in the rendered audio over time as a result of application of the varied audio-rendering directives over time.

In FIG. 3, the audio-rendering directives are audio-loudness specifications, such as loudness settings for a given audio channel or object. As shown in part A of FIG. 3, the audio-loudness specifications over the illustrated time range as received by encoder 200 are constant, all specifying an example audio loudness of 30 dB. If equipment at the destination would render the audio of the associated frames according to these audio-loudness specifications, the loudness of the resulting rendered audio may therefore be constant over this time range.

The encoder 200 may detect that the audio-loudness specifications through this time range are constant and may therefore conclude that this time range is a suitable time range the audio-loudness specifications in which to encode the bit sequence.

As shown in part B of FIG. 3, the encoder 200 may thus encode the bit sequence into the audio-loudness specifications of this time range, by varying the audio-loudness specifications over time in a manner that represents the bit sequence. In particular, in the example shown, the encoder 200 may encode the bit sequence by varying the audio-loudness specifications corresponding with frames 5 through 9. In the example shown, for instance, the encoder 200 encodes each one-bit by increasing the corresponding audio-loudness specification by 1 dB, and the encoder 200 encodes each zero-bit by decreasing the corresponding audio-loudness specification by 1 dB. As a result, the audio-loudness specifications for frames 5through 9 change from being {30 dB, 30 dB, 30 dB, 30 dB, 30 dB} to being {31 dB, 29 dB, 31 dB, 31 dB, 29 dB}.

With this variation in audio-loudness specifications over time, when equipment at the destination 120 renders the audio according to the audio-loudness specifications over the illustrated time range, the loudness of the resulting rendered audio may be constant in frames 1 through 4 but may then vary in frames 5 through 9 in a manner that represents the bit sequence. The decoder 202 could therefore extract the bit sequence from the rendered audio by mapping the audio loudness of each rendered frame in turn to an associated bit value. For instance, the decoder could map to a one-bit each frame that has increased loudness of 31 dB and could map to a zero-bit each frame that has decreased loudness of 29 dB. Thus the decoder 202 could uncover the bit sequence 10110 from audio frames 5 through 9 by detecting variations in audio loudness of the rendered audio frames resulting from the audio frames being rendered in accordance with the varied audio-loudness specifications representing the bit sequence.

Turning next to FIG. 4, the illustrated audio-rendering directives in this example are spatial-audio specifications, such as specifications of a perceptual-audio direction angle (e.g., relative channel loudness settings) for a given audio object. As shown in part A of FIG. 4, the audio-loudness specifications over the illustrated time range as received by encoder 200 are constant, all specifying an example perceptual-audio direction of 0°. If equipment at the destination would render the audio of the associated frames according to these spatial-audio specifications, the perceptual-audio direction of the resulting rendered audio may therefore be constant over this time range.

In this example, the encoder 200 may detect that the spatial-audio specifications through this time range are constant and may therefore conclude that this time range is a suitable time range the spatial-audio specifications in which to encode the bit sequence.

As shown in part B of FIG. 4, the encoder 200 may thus encode the bit sequence into the spatial-audio specifications of this time range, by varying the spatial-audio specifications over time in a manner that represents the bit sequence. In particular, in the example shown, the encoder 200 may encode the bit sequence by varying the specified perceptual-audio directions corresponding with frames 5 through 9. In the example shown, for instance, the encoder 200 encodes each one-bit by increasing the corresponding perceptual-audio-direction specification by 3°, and the encoder 200 encodes each zero-bit by decreasing the corresponding perceptual-audio-direction specification by 3°. As a result, the perceptual-audio-direction specifications for frames 5 through 9 change from being {0°, 0°, 0°, 0°, 0°} to being {+3°, −3°, +3°, +3°, −3°}.

With this variation in spatial-audio specifications over time, when equipment at the destination 120 renders the audio according to the spatial-audio specifications over the illustrated time range, the perceptual-audio direction of the resulting rendered audio may be constant in frames 1 through 4 but may then vary in frames 5 through 9 in a manner that represents the bit sequence. The decoder 202 could therefore extract the bit sequence from the rendered audio by mapping the perceptual-audio-direction of each rendered frame in turn to an associated bit value. For instance, the decoder could map to a one-bit each frame that has an increased perceptual-audio direction of +3° and could map to a zero-bit each frame that has a decreased perceptual-audio direction of −3°. Thus the decoder 202 could uncover the bit sequence 10110 from audio frames 5 through 9 by detecting variations in perceptual-audio direction of the rendered audio frames resulting from the audio frames being rendered in accordance with the varied spatial-audio specifications representing the bit sequence.

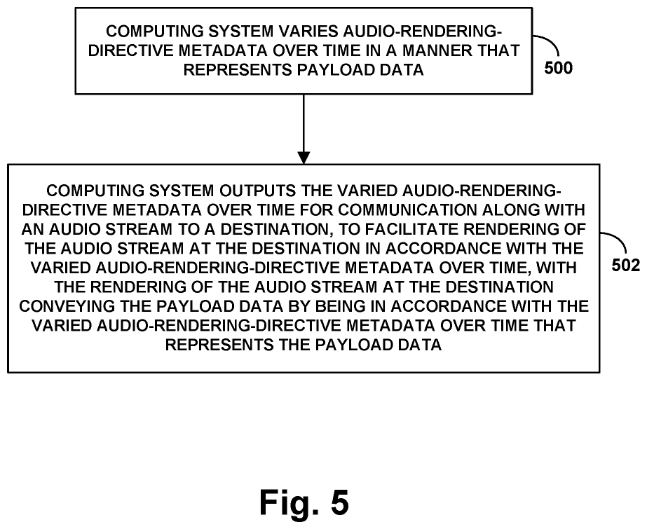

FIG. 5 is a flow chart illustrating a method that could be carried out in accordance with the present disclosure to facilitate communicating payload data to a destination. As shown in FIG. 5, at block 500, the method could include a computing system varying audio-rendering-directive metadata over time in a manner that represents the payload data. Further, at block 502, the method could include the computing system outputting the varied audio-rendering-directive metadata over time for communication along with an audio stream to the destination, to facilitate rendering of the audio stream at the destination in accordance with the varied audio-rendering-directive metadata over time, with the rendering of the audio stream at the destination conveying the payload data by being in accordance with the varied audio-rendering-directive metadata over time that represents the payload data.

In an example implementation, the computing system could generate a sequence of metadata objects that specify values of an audio-rendering property (e.g., loudness or perceptual-audio direction, among other possibilities) to be applied in rendering a sequence of audio segments of an audio stream, with the sequence of metadata objects defining a sequence of the values of the audio-rendering property by each metadata object of the sequence of metadata objects specifying a respective value of the audio-rendering property to be applied in rendering a respective audio segment of the sequence of audio segments of the audio stream, and with the generating of the sequence of metadata objects including setting the sequence of values of the audio-rendering property to cooperatively represent the payload data. For instance, the computing system could do this as part of initial creation of the sequence of metadata objects, or by varying an already-created sequence of metadata objects.

Further, the computing system could then communicate to a destination this generated sequence of metadata objects along with the audio stream, to facilitate corresponding rendering of the audio stream at the destination in accordance with the sequence of values of the audio-rendering property. And in line with the discussion above, the rendering of the audio stream at the destination could convey the payload by being in accordance with the sequence of values of the audio-rendering property that cooperatively represents the payload data.

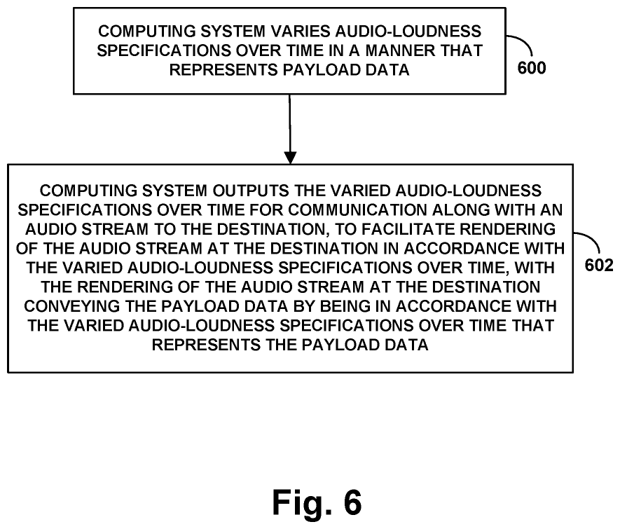

FIG. 6 is another flow chart illustrating an example method where the audio-rendering-directive metadata includes audio-loudness specifications over time. Thus, as shown in FIG. 6, at block 600, the method could include a computing system varying audio-loudness specifications over time in a manner that represents the payload data. Further, at block 602, the method could include the computing system outputting the varied audio-loudness specifications over time for communication along with an audio stream to the destination, to facilitate rendering of the audio stream at the destination in accordance with the varied audio-loudness specifications over time, with the rendering of the audio stream at the destination conveying the payload data by being in accordance with the varied audio-loudness specifications over time that represents the payload data.

In line with the discussion above, the payload data could comprise a bit sequence that includes zero-bits and one-bits, and the act of varying the audio-loudness specifications over time in a manner that represents the payload data could involve varying the audio-loudness specifications over time with a first variation in audio-loudness specification for each zero-bit and a second variation in audio-loudness specification for each one-bit, with the first variation differing from the second variation. For instance, the first variation could be decreasing the audio-loudness specification by a predefined extent, and the second variation could be increasing the audio-loudness specification by a predefined extent.

Further, as discussed above, the payload data could comprise a bit sequence, and the act of varying the audio-loudness specifications over time in a manner that represents the payload data could involve (i) spreading the bit sequence with a PN sequence, to generate a spread bit sequence including zero-bits and one-bits and (ii) varying the audio-loudness specifications over time with a first variation in audio-loudness specification for each zero-bit of the spread bit sequence and a second variation in audio-loudness specification for each one-bit of the spread bit sequence, with the first variation differing from the second variation. Here too, for instance, the first variation could be decreasing the audio-loudness specification by a predefined extent, and the second variation could be increasing the audio-loudness specification by a predefined extent.

In addition, as discussed above, the audio stream could define (i.e., include) a sequence of audio frames, in which case the audio-rendering-directive metadata could define an audio-loudness specification respectively per frame for each audio frame of the sequence of audio frames, and varying the audio-loudness specifications over time could involve varying the audio-loudness specifications from audio frame to audio frame.

Further, as discussed above, the method could include detecting that the audio-loudness specifications are relatively constant through a time period of the audio-rendering-directive metadata (e.g., that the audio-loudness specifications are constant throughout the time period or are constant or predictable enough throughout the time period to form a reasonable baseline as discussed above). In that case, the act of varying the audio-loudness specifications over time in a manner that represents the payload data could involve, based on the detecting, performing the varying of audio-loudness specifications in the time period of the audio-rendering-directive metadata.

Still further, as discussed above, the act of varying the audio-loudness specifications over time could involve varying the audio-loudness specifications to an extent that, when the audio stream is rendered in accordance with the varied audio-loudness specifications, resulting changes in audio loudness are not human perceptible but are machine perceptible.

In addition, as noted above, the payload data could comprise at least a portion of an identifier of the audio stream.

Further, as noted above, the method could include the computing system receiving the audio-rendering-directive metadata, in which case the act of varying the audio-rendering-directive metadata could involve modifying the received audio-rendering-directive metadata.

Still further, as noted above, the act of communicating to the destination the varied audio-rendering-directive metadata over time along with the audio stream could involve transmitting the varied audio-rendering-directive metadata over time in a virtual channel along with audio data of the audio stream.

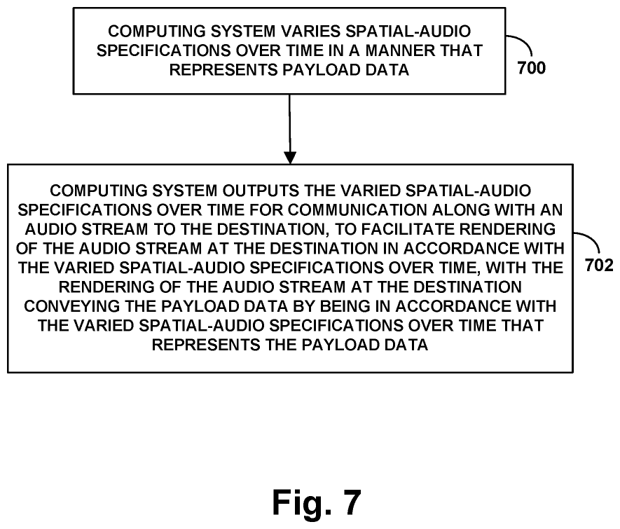

FIG. 7 is another flow chart illustrating an example method where the audio-rendering-directive metadata includes spatial-audio specifications over time. Thus, as shown in FIG. 7, at block 700, the method could include a computing system varying spatial-audio specifications over time in a manner that represents the payload data. Further, at block 702, the method could include the computing system outputting the varied spatial-audio specifications over time for communication along with an audio stream to the destination, to facilitate rendering of the audio stream at the destination in accordance with the varied spatial-audio specifications over time, with the rendering of the audio stream at the destination conveying the payload data by being in accordance with the varied spatial-audio specifications over time that represents the payload data.

In line with the discussion above, each spatial-audio specification of the spatial-audio specifications could define a respective perceptual-audio-direction for multi-speaker audio rendering. For instance, each spatial-audio specification could specify an angle for output of particular object audio, which a renderer could apply by setting relative channel loudness levels or the like to create the indicated perceptual-audio direction. Or each spatial-audio specification could implicitly indicate the desired angle by specifying the relative channel loudness levels, which the renderer could apply in order to create an associated perceptual-audio direction. As indicated above, the act of varying the spatial-audio specifications could thus involve varying the perceptual-audio-direction defined expressly or implicitly by each spatial-audio specification.

As further discussed above, the payload data in this example as well could comprise a bit sequence that includes zero-bits and one-bits, and the act of varying the spatial-audio specifications over time in a manner that represents the payload data could involve varying the spatial-audio specifications over time with a first variation in spatial-audio specification for each zero-bit and a second variation in spatial-audio specification for each one-bit, with the first variation differing from the second variation. For instance, the first variation could be decreasing a perceptual-audio-direction specification by a predefined extent, and the second variation could be increasing the perceptual-audio-direction specification by a predefined extent.

Further, as discussed above, the payload data could comprise a bit sequence, and the act of varying the audio-loudness specifications over time in a manner that represents the payload data could involve (i) spreading the bit sequence with a PN sequence, to generate a spread bit sequence including zero-bits and one-bits and (ii) varying the spatial-audio specifications over time with a first variation in spatial-audio specification for each zero-bit of the spread bit sequence and a second variation in spatial-audio specification for each one-bit of the spread bit sequence, with the first variation differing from the second variation. Here too, for instance, the first variation could be decreasing a perceptual-audio-direction specification by a predefined extent, and the second variation could be increasing the perceptual-audio-direction specification by a predefined extent.

In addition, as discussed above, the audio stream could define (i.e., include) a sequence of audio frames, in which case the audio-rendering-directive metadata could define a spatial-audio specification respectively per frame for each audio frame of the sequence of audio frames, and varying the spatial-audio specifications over time could involve varying the spatial-audio specifications from audio frame to audio frame.

Further, as discussed above, the method could include detecting that the spatial-audio specifications are relatively constant through a time period of the audio-rendering-directive metadata (e.g., that the spatial-audio specifications are constant throughout the time period or are constant or predictable enough throughout the time period to form a reasonable baseline as discussed above). In that case, the act of varying the spatial-audio specifications over time in a manner that represents the payload data could involve, based on the detecting, performing the varying of spatial-audio specifications in the time period of the audio-rendering-directive metadata.

Still further, as discussed above, the act of varying the spatial-audio specifications over time could involve varying the spatial-audio specifications to an extent that, when the audio stream is rendered in accordance with the varied spatial-audio specifications, resulting changes in spatial audio are not human perceptible but are machine perceptible.

In addition, here too as noted above, the payload data could comprise at least a portion of an identifier of the audio stream. Further, as noted above, the method could include the computing system receiving the audio-rendering-directive metadata, in which case the act of varying the audio-rendering-directive metadata could involve modifying the received audio-rendering-directive metadata. And the act of communicating to the destination the varied audio-rendering-directive metadata over time along with the audio stream could involve transmitting the varied audio-rendering-directive metadata over time in a virtual channel along with audio data of the audio stream.

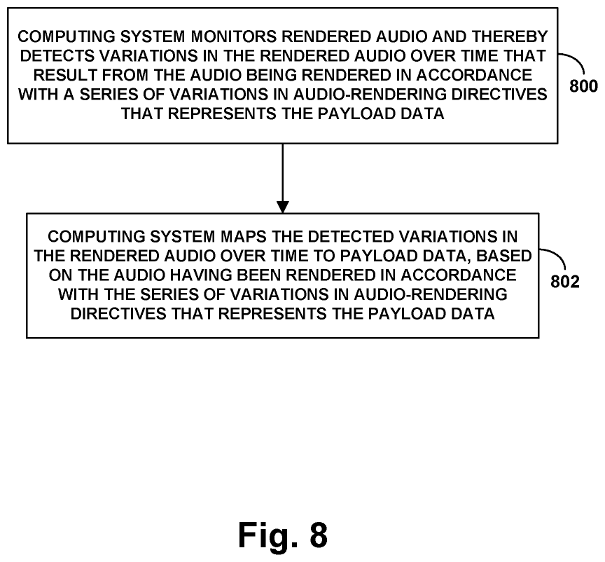

FIG. 8 is next a flow chart illustrating a method that could be carried out in relation to extracting payload data from rendered audio in line with the discussion above. As shown in FIG. 8, at block 800, a computing system could monitor rendered audio and thereby detect variations in the rendered audio over time that result from the audio being rendered in accordance with a series of variations in audio-rendering directives that represents the payload data. Further, at block 802, the computing system could map the detected variations in the rendered audio over time to the payload data, based on the audio having been rendered in accordance with the series of variations in audio-rendering directives that represents the payload data.

In line with the discussion above, the audio-rendering directives in this method could include audio-loudness directives and/or spatial-audio directives, among other possibilities. Thus, by detecting variations in audio loudness and/or spatial audio configuration of the rendered audio over time, the computing system could extract the payload data based on the audio having been rendered in accordance with a series of variations in audio-rendering directives that represents the payload data.

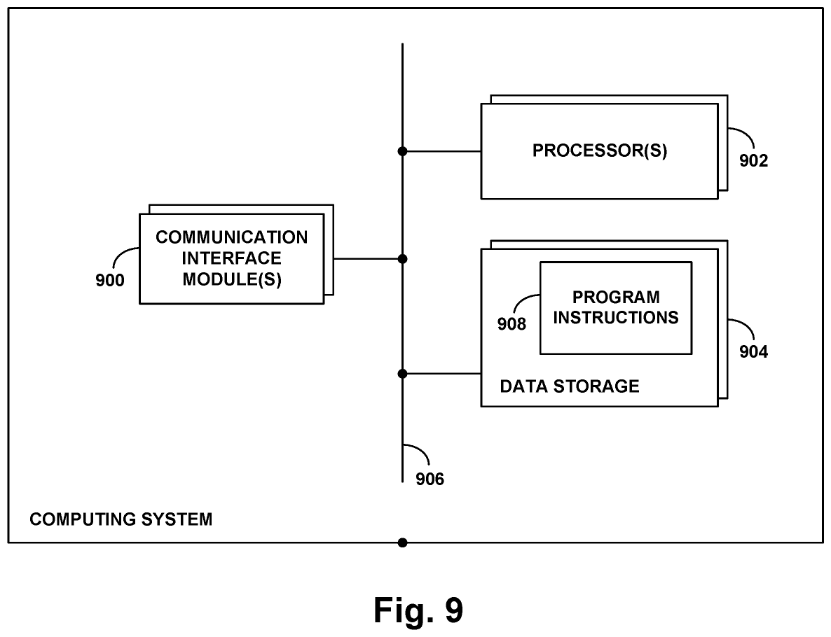

FIG. 9 is a simplified block diagram of a computing system that could be configured to carry out various operations such as those discussed above, including for instance the operations of encoder 200 and/or the operations of decoder 202. As shown in FIG. 9, the example computing system could include at least one communication interface 900, at least one processor 902, and at least one non-transitory data storage 904, which could integrated together or communicatively linked together by a system bus, network, or one or more other connection mechanisms 906.

The at least one communication interface 900 could comprise one or more interfaces to facilitate wired and/or wireless communication with one or more other entities. Examples of such interfaces could include, without limitation, wired Ethernet interfaces and/or WiFi interfaces.

In an encoder, for instance, a communication interface may facilitate receiving a media stream that includes both audio data and associated audio-rendering-directive metadata, and may facilitate transmitting to a destination a modified version of the media stream, with the audio-rendering-directive metadata varied as noted above. In a decoder, on the other hand, a communication interface may facilitate reporting to a back office system payload data extracted from rendered audio based on the audio having been rendered in accordance with a series of variations in audio-rendering-directive metadata that represents the payload data.

The at least one processor 902 could comprise one or more general purpose processing units (e.g., microprocessors) and/or one or more specialized processing units (e.g., digital signal processors, dedicated audio processors, dedicated watermark processors, etc.) Further, the at least one non-transitory data storage 904 could comprise one or more volatile and/or non-volatile storage components (e.g., flash, optical, magnetic, ROM, RAM, EPROM, EEPROM, etc.), which may be integrated in whole or in part with the at least one processor 902. As further shown, the at least one non-transitory data storage 904 could store program instructions 908, which may be executable by the at least one processor 902 to carry out various computing-system operations described herein, such as the operations described with respect to the flow charts above.

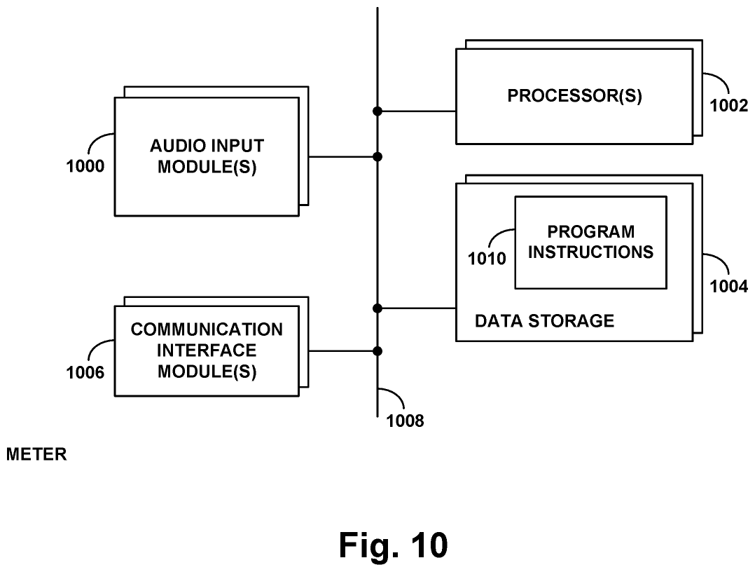

FIG. 10 is a simplified block diagram of a meter that could operate to extract payload data from rendered audio in line with the discussion above. As noted above, such a meter could be positioned and/or connected in a manner that enables the meter to monitor rendered audio so as to detect variations in the rendered audio over time resulting from the audio having been rendered in accordance with the series of variations in audio-rendering-directive metadata representing the payload data. For instance, the meter could be positions and/or connected so that it can monitor rendered audio respectively from each of various audio channels.

As shown in FIG. 10, the example meter includes one or more audio-input modules 1000, at least one processor 1002, at least one non-transitory data storage 1004, and at least one communication interface 1006, which could integrated together or communicatively linked together by a system bus, network, or one or more other connection mechanisms 1008.

The one or more audio-input modules 1000 may comprise one or more microphones and/or other audio input mechanisms configured to receive acoustic audio rendered by one or more sound speakers and/or to otherwise receive rendered audio signals.

The at least one processor 1002 could comprise one or more general purpose processing units (e.g., microprocessors) and/or one or more specialized processing units (e.g., digital signal processors, dedicated audio processors, dedicated watermark processors, etc.) Further, the at least one non-transitory data storage 1004 could comprise one or more volatile and/or non-volatile storage components (e.g., flash, optical, magnetic, ROM, RAM, EPROM, EEPROM, etc.), which may be integrated in whole or in part with the at least one processor 1002. Still further, the at least one non-transitory data storage 1004 could store program instructions 1010, which may be executable by the at least one processor 1002 to carry out various computing-system operations described herein, such as the operations described with respect to the flow charts above.

The at least one communication interface 1006 could then comprise one or more wired and/or wireless network interfaces, such as wired Ethernet interfaces and/or WiFi interfaces, to facilitate communication with other entities. For instance, the meter may use such a communication interface to report to a back office system payload data extracted in the manner described above.

The present disclosure also contemplates at least one non-transitory computer readable medium that is encoded with, stores, or otherwise embodies program instructions executable by at least one processor to carry out various operations as described above.

Exemplary embodiments have been described above. Those skilled in the art will understand, however, that changes and modifications may be made to these embodiments without departing from the true scope and spirit of the invention.

What is claimed is:

1. A method to facilitate communicating payload data to a destination, the method comprising:
varying, by a computing system, audio-rendering-directive metadata over time in a manner that represents the payload data; and
outputting, by the computing system, the varied audio-rendering-directive metadata over time for communication along with an audio stream to the destination,, to facilitate rendering of the audio stream at the destination in accordance with the varied audio-rendering-directive metadata over time,
wherein the rendering of the audio stream at the destination conveys the payload data by being in accordance with the varied audio-rendering-directive metadata over time that represents the payload data, and
wherein the audio-rendering-directive metadata includes spatial-audio specifications over time, and wherein varying the audio-rendering-directive metadata over time in a manner that represents the payload data comprises varying the spatial-audio specifications over time in a manner that represents the payload data.

2. The method of claim 1, wherein each spatial-audio specification of the spatial-audio specifications defines a respective perceptual-audio-direction for multi-speaker audio rendering, and wherein varying the spatial-audio specifications comprises varying the perceptual-audio-direction defined by each spatial-audio specification.

3. The method of claim 1, wherein the payload data is comprises a bit sequence including zero-bits and one-bits, and wherein varying the spatial-audio specifications over time in a manner that represents the payload data comprises varying the spatial-audio specifications over time with a first variation in spatial-audio specification for each zero-bit and a second variation in spatial-audio specification for each one-bit, the first variation differing from the second variation.

4. The method of claim 1, wherein the payload data comprises a bit sequence, and wherein varying the spatial-audio specifications over time in a manner that represents the payload data comprises:
spreading the bit sequence with a pseudo-noise (PN) sequence, to generate a spread bit sequence including zero-bits and one-bits; and
varying the spatial-audio specifications over time with a first variation in spatial-audio specification for each zero-bit of the spread bit sequence and a second variation in spatial-audio specification for each one-bit of the spread bit sequence, the first variation differing from the second variation.

5. The method of claim 1, wherein the audio stream defines a sequence of audio frames, wherein the audio-rendering-directive metadata defines a spatial-audio specification respectively per frame for each audio frame of the sequence of audio frames, and wherein varying the spatial-audio specifications over time comprises varying the spatial-audio specifications from audio frame to audio frame.

6. The method of claim 1, further comprising:
detecting that the spatial-audio specifications are relatively constant through a time period of the audio-rendering-directive metadata,
wherein varying the spatial-audio specifications over time in a manner that represents the payload data comprises, based on the detecting, performing the varying of spatial-audio specifications in the time period of the audio-rendering-directive metadata.

7. The method of claim 1, wherein varying the spatial-audio specifications over time comprises varying the spatial-audio specifications to an extent that, when the audio stream is rendered in accordance with the varied spatial-audio specifications, resulting changes in spatial audio are not human perceptible but are machine perceptible.

8. The method of claim 1, wherein the payload data comprises at least a portion of an identifier of the audio stream.

9. The method of claim 1, further comprising receiving the audio-rendering-directive metadata, wherein varying the audio-rendering-directive metadata comprises modifying the received audio-rendering-directive metadata.

10. The method of claim 1, wherein communicating to the destination the varied audio-rendering-directive metadata over time along with the audio stream comprises transmitting the varied audio-rendering-directive metadata over time in a virtual channel along with audio data of the audio stream.

11. A computing system comprising:
at least one processor;
at least one non-transitory data storage; and
program instructions stored in the at least one non-transitory data storage and executable by the at least one processor to carry out operations to facilitate communicating payload data to a destination, the operations including:
varying audio-rendering-directive metadata over time in a manner that represents the payload data, and
outputting the varied audio-rendering-directive metadata over time for communication along with an audio stream to the destination, to facilitate rendering of the audio stream at the destination in accordance with the varied audio-rendering-directive metadata over time,
wherein the rendering of the audio stream at the destination conveys the payload data by being in accordance with the varied audio-rendering-directive metadata over time that represents the payload data, and
wherein the audio-rendering-directive metadata includes spatial-audio specifications over time, and wherein varying the audio-rendering-directive metadata over time in a manner that represents the payload data comprises varying the spatial-audio specifications over time in a manner that represents the payload data.

12. The computing system of claim 11, wherein each spatial-audio specification of the spatial-audio specifications defines a respective perceptual-audio-direction for multi-speaker audio rendering, and wherein varying the spatial-audio specifications comprises varying the perceptual-audio-direction defined by each spatial-audio specification.

13. The computing system of claim 11, wherein the payload data comprises a bit sequence including zero-bits and one-bits, and wherein varying the spatial-audio specifications over time in a manner that represents the payload data comprises varying the spatial-audio specifications over time with a first variation in spatial-audio specification for each zero-bit and a second variation in spatial-audio specification for each one-bit, the first variation differing from the second variation.

14. The computing system of claim 11, wherein the payload data comprises a bit sequence, and wherein varying the spatial-audio specifications over time in a manner that represents the payload data comprises:
spreading the bit sequence with a pseudo-noise (PN) sequence, to generate a spread bit sequence including zero-bits and one-bits; and
varying the spatial-audio specifications over time with a first variation in spatial-audio specification for each zero-bit of the spread bit sequence and a second variation in spatial-audio specification for each one-bit of the spread bit sequence, the first variation differing from the second variation.

15. The computing system of claim 11, wherein the audio stream defines a sequence of audio frames, wherein the audio-rendering-directive metadata defines a spatial-audio specification respectively per frame for each audio frame of the sequence of audio frames, and wherein varying the spatial-audio specifications over time comprises varying the spatial-audio specifications from audio frame to audio frame.

16. The computing of claim 11, wherein the operations additionally include:
detecting that the spatial-audio specifications are relatively constant through a time period of the audio-rendering-directive metadata,
wherein varying the spatial-audio specifications over time in a manner that represents the payload data comprises, based on the detecting, performing the varying of spatial-audio specifications in the time period of the audio-rendering-directive metadata.

17. The computing system of claim 11, wherein varying the spatial-audio specifications over time comprises varying the spatial-audio specifications to an extent that, when the audio stream is rendered in accordance with the varied spatial-audio specifications, resulting changes in spatial audio are not human perceptible but are machine perceptible.

18. At least one non-transitory computer-readable medium storing program instructions executable to carry out operations to facilitate communicating payload data to a destination, the operations including:
varying audio-rendering-directive metadata over time in a manner that represents the payload data; and
outputting the varied audio-rendering-directive metadata over time for communication along with an audio stream to the destination, to facilitate rendering of the audio stream at the destination in accordance with the varied audio-rendering-directive metadata over time,
wherein the rendering of the audio stream at the destination conveys the payload data by being in accordance with the varied audio-rendering-directive metadata over time that represents the payload, and
wherein the audio-rendering-directive metadata includes spatial-audio specifications over time, and wherein varying the audio-rendering-directive metadata over time in a manner that represents the payload data comprises varying the spatial-audio specifications over time in a manner that represents the payload data.

19. The at least one non-transitory computer-readable medium of claim 18, wherein each spatial-audio specification of the spatial-audio specifications defines a respective perceptual-audio-direction for multi-speaker audio rendering, and wherein varying the spatial-audio specifications comprises varying the perceptual-audio-direction defined respectively by each spatial-audio specification.

20. The at least one non-transitory computer-readable medium of claim 18, wherein the payload data comprises a bit sequence including zero-bits and one-bits, and wherein varying the spatial-audio specifications over time in a manner that represents the payload data comprises varying the spatial-audio specifications over time with a first variation in spatial-audio specification for each zero-bit and a second variation in spatial-audio specification for each one-bit, the first variation differing from the second variation.
